(19) United States
(12) Patent Application Publication
(10) Pub. No.: US 2010/0308586 A1
(43) Pub. Date: Dec. 9, 2010

(54) Wind Turbine Systems Using Continuously Variable Transmissions and Controls

(75) Inventors: Andrew Alfonso Frank, Davis, CA (US); James Raymond Winkelman, Bloomfield, MI (US)

Correspondence Address: Efficient Drive Trains, Inc., 2138 Chianti Drive, Santa Rosa, CA, 95403, US

(73) Assignee: EFFICIENT DRIVETRAINS, INC, Palo Alto, CA (US)

(21) Appl. No.: 12/863,948

(22) PCT Filed: Feb. 24, 2009
(86) PCT No.: PCT/US09/34975

§ 371 Date: Aug. 17, 2010

Related U.S. Application Data
(60) Provisional application No. 61/032,665, filed on Feb. 29, 2008.

(51) Int. Cl. F03D 7/00; F03D 11/02

(52) U.S. Cl. 290/44

(57) ABSTRACT

A wind turbine system is disclosed comprising: a plurality of turbine blades; a continuously variable transmission coupled to said plurality of turbine blades; a generator coupled to said continuously variable transmission; wherein said generator generates electricity and outputs said electricity to a load/grid; and a controller providing control signals as a filtered function of power to said continuously variable transmission. The controller of said wind turbine system may also continuously maintain the parameter dP/dR substantially zero where P is power and R is the ratio of the transmission.

### FIELD OF INVENTION

The present application is related to wind turbine systems, and more particularly, to systems that comprises continuously variable transmissions (CVTs) and advanced control techniques for such improved wind turbine systems.

Conventional wind turbines concern themselves with the efficient conversion of kinetic wind energy into electrical energy that, in turn, is either directly emitted to the electrical grid or provisionally stored in some storage (e.g. batteries, controlled capacitor banks) before being sent to the grid or load.

FIGS. 1 and 2 depict two such conventional wind turbine systems—systems 100 and 200, respectively. Both systems 100 and 200 comprise same or similar blocks—turbine blades 102, gear set 104, pitch controller 106, induction generator 108—which in turn are coupled to the electrical load/grid 110. The difference occurs in the manner in which systems 100 and 200 couple to the grid—e.g. system 100 comprises rotor converter 112 while system 200 comprises a controlled capacitor bank 212.

In operation, both systems 100 and 200 convert the kinetic energy of wind via turbine blades 102 into electrical energy via induction generator 108. Intermediate gear set 104 typically comprises a fixed ratio—examples of such are provided in U.S. Pat. Nos. 6,420,808 and 7,008,348 which are incorporated herein by reference. The hub speed (which could be the speed of the shaft on either side of the gear box, if it is fixed ratio control) may be used by pitch controller 106 to change the pitch of the turbine blades to accomplish (among other things) an optimum power throughput of the wind turbine depending upon the prevailing wind condition. Examples of such pitch controllers include U.S. Pat. Nos. 4,339,666; 4,348,156; 4,703,189 and 7,095,131 which are hereby incorporated by reference.

Gear 104 provides the necessary mechanical coupling to induction generator 108 to convert the mechanical energy into electrical energy. Once generated, the electrical energy is typically desired to be placed onto the electrical grid for wide distribution. One problem that wind turbine system designers face is the optimal matching of conditions (e.g. AC frequency matching and reactive power requirement) to place the energy onto the grid. FIG. 1 depicts one method of accomplishing this with rotor converter 112—which provides feedback for AC frequency matching. Examples of rotor control are found in U.S. Pat. Nos. 5,798,631; 7,215,035 and 7,239,036 which are incorporated herein by reference. FIG. 2 depicts yet another method with controlled capacitor bank 212 to provide sufficient reactive power for self excitation. Examples of such capacitor banks include U.S. Pat. Nos. 5,225,712 and 7,071,579 which are incorporated herein by reference.

Adding a CVT to wind turbine systems have been considered in the art. Examples include United States Patent Publication Number 2007/0049450 which is hereby incorporated by reference. In the article “The Advantages of Using Continuously Variable Transmissions in Wind Power Systems” by Mangialardi and Mantriota, Renewable Energy Vol. 2, No. 3, pp. 201-209, 1992, there is described a simplified wind turbine system that employs a CVT. Mangialardi describes one advantage of such a system is that the CVT allows for the adjustment of the transmission ratio between the shaft of the wind device and that of the electric generator. This allows for the output of electrical power directly to the grid without the use of frequency-controlling electronic devices. While accomplishing this, Mangialardi seeks to maximize the efficiency of the wind turbine system. In order for this system to output electrical power to the grid without use of any frequency controlling devices requires that the rotor of the generator operate within a small tolerance of the frequency of the grid specification.

The requirement to operate around synchronous speed, the grid frequency, comes from using an induction generator. Typically, the induction generator should operate at a speed no more than 5 to 10% greater than the electrical frequency in order to be a useful power generator. Thus, Mangialardi calculates a desired transmission ratio from the aerodynamic characteristics of the blade system at different wind speeds, i.e. a map/table. The system then tries to maximize the electric power generation by scheduling transmission ratio as a function of wind speed. It may be desirable to have a control system which finds the maximum in real time without the use of such tables.

Conventional CVTs have been limited of late as to their peak torque and power ratings as to which systems such CVTs could be implemented. Advances in CVT chain drives (as opposed to belt driven systems and other CVT systems) have greatly expanded the applicability of CVTs into high power, high torque systems. Such a CVT chain driven system is described in U.S. Pat. Nos. 5,728,021 and 6,739,994 which are herein incorporated by reference.

Advanced controls for such CVT systems have also been considered for use in cars and hybrid electric vehicles. Examples include U.S. Pat. Nos. 6,847,189 and 7,261,672 and in United States Patent Application Numbers 2004060751 and 2008032858 which are hereby incorporated by reference. The '672 patent describes a control method for operating a CVT in a hybrid electric vehicle by controlling the rate of change of transmission ratio in order to hold the internal combustion engine on its ideal operating line and using the electric motor as an effective load leveler. In addition, the CVT could be a streamline in-line CVT configuration as described in United States Patent Application Number 2005107193 which is hereby incorporated by reference.

### BRIEF DESCRIPTION OF THE DRAWINGS

The organization and methods of operation of the wind turbine systems and techniques disclosed herein are best understood from the following description of several illustrated embodiments when read in connection with the following drawings in which the same reference numbers are used throughout the drawings to refer to the same or like parts:

FIG. 1 is a conventional wind turbine system having a rotor converter.

FIG. 2 is a conventional wind turbine system having a controlled capacitor bank.

FIG. 3A depicts one embodiment of a presently claimed wind turbine system comprising a controller that controls rate of change of transmission ratio.

FIG. 3B depicts curves of power versus CVT ratio and the curve of dP/dR.

FIGS. 4 through 7 are alternative embodiments of present claimed wind turbine systems.

FIG. 8 is a conventional wind turbine system having a permanent magnet generator.

FIG. 9A depicts one embodiment of a presently claimed wind turbine system having a permanent magnet generator with an AC/AC link.

FIG. 9B depicts another embodiment of a presently claimed wind turbine system having a permanent magnet generator with a battery and a DC/AC converter.

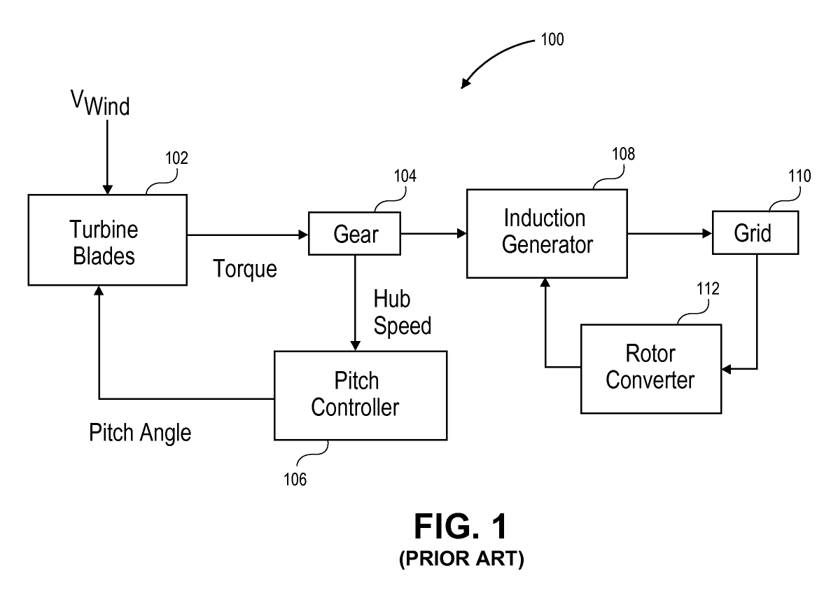

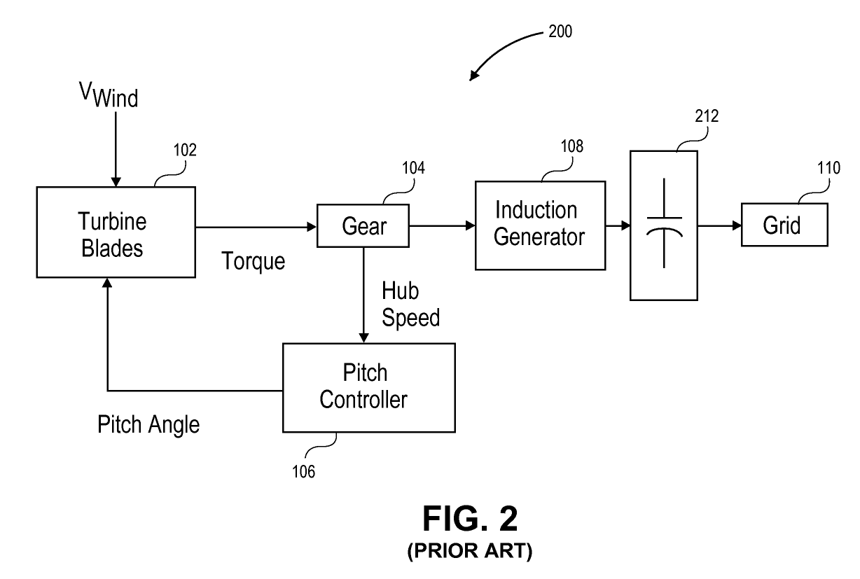

### TECHNICAL FIELD

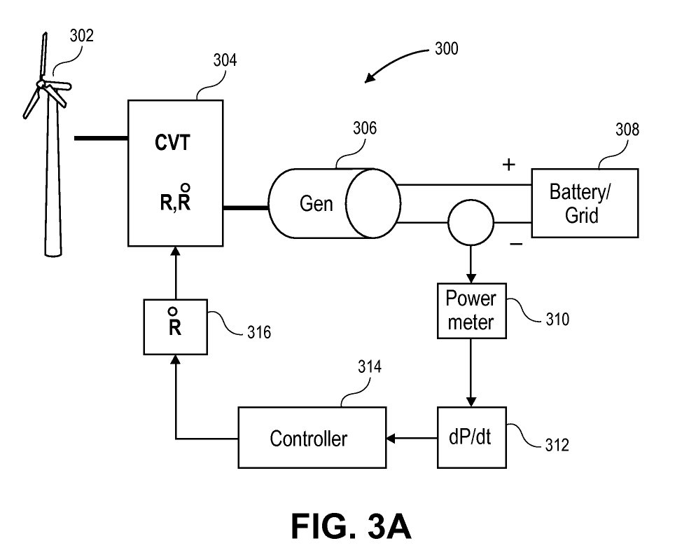

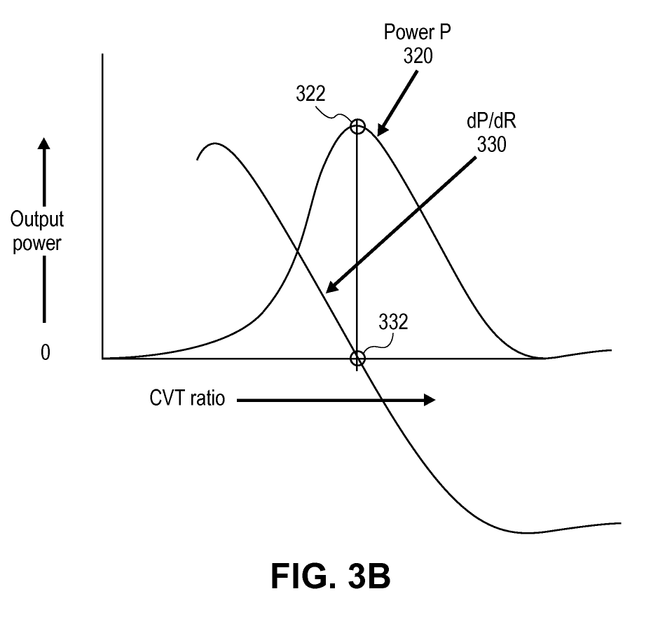

In one embodiment of the wind turbine system 300 as shown in FIG. 3A, turbine blades 302 are mechanically coupled to CVT 304. As will be further described herein, CVT has sensors that determine the transmission ratio at any given time and thus the rate of change of ratio (i.e. dR/dt) may be either calculated there from or otherwise detected. Such sensors are well known in the art. The output shaft of the CVT turns the rotor within generator 306 to convert mechanical energy into electrical energy. Generator 306 may either be a doubly fed induction generator (and thereby use some conventional techniques for interfacing to the grid) or a singly fed induction generator (requiring no rotor controls). If a singly fed induction generator is used, then the system will have significantly reduced costs when compared to a system using a doubly fed induction generator. Alternatively, the system could use a permanent magnet generator.

Electricity thereby generated may be fed into Load/Battery/grid 308. Grid 308 may also be some other storage systems—e.g. batteries, capacitors, load or the like. Any generated DC power stored in a battery bank or the like could then be synchronously converted to AC to match the conventional power grid operating frequency and phase. The electricity may be tapped by power sensor or meter 310 which could take readings of voltage and current at a given time to determine power generated in the usual fashion. Differential power readings may give an indication of the rate of change of power generated at block 312 (i.e. dP/dt).

Controller 314 may take the indications of both dP/dt and dR/dt from the power meters and the CVT respectively and calculate or otherwise generate dP/dR. Under known control theory, this indication of dP/dR may be used to hold the wind turbine system at its maximum power production—without regard to the prevailing wind conditions. FIG. 3B shows the graphs of power versus CVT ratio (graph 320) and the graph of dP/dR derived from graph 320 (graph 330). As may be seen, peak power is achieved at point 322 on graph 320. This point also corresponds to dP/dR=0 on graph 332. Once controller 314 has determined dP/dR, a control signal 316 is generated that is or based upon dR/dt or a suitable filtered function of power thereof and fed back to the CVT. This control signal is thereby used by the CVT in order to change the rate of ratio change to keep the system substantially at dP/dR=0. As is known, CVT ratio rate may be controlled by hydraulic pressure to provide accurate control of CVT ratio.

It should be appreciated that one possible input to the controller is electrical power. From electrical power signal, it is possible to generate the time rate of change of electrical power. Such a differentiation may be construed as a filtering of electrical power. Mathematically differentiating is precise, but as a practical matter, this should be done within a certain frequency range so as not to introduce excessive noise into the process. So, such a practical filter may be either a hardware or software filter or a combination of both.

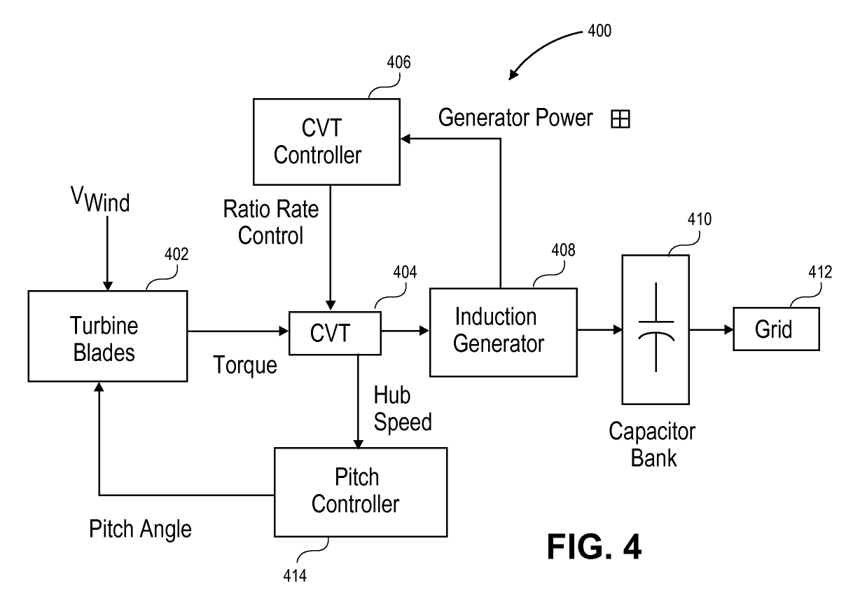

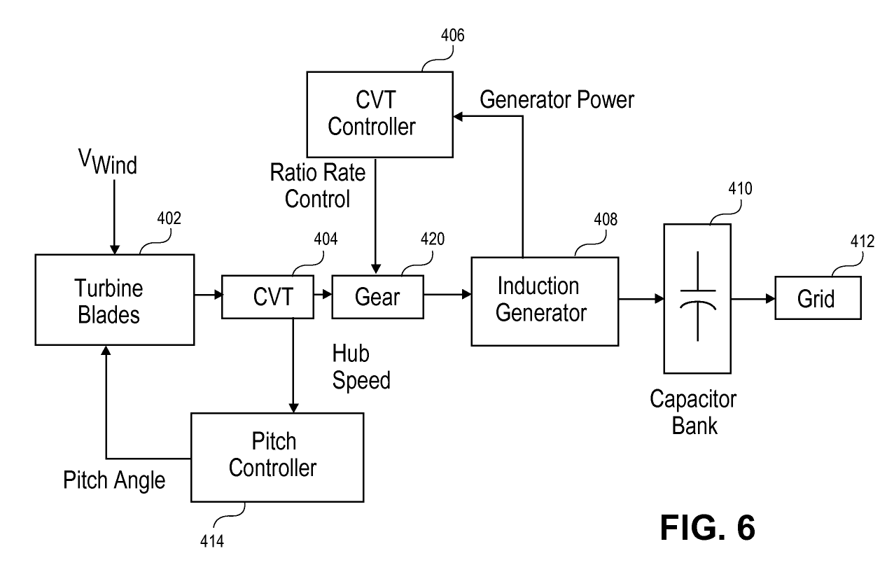

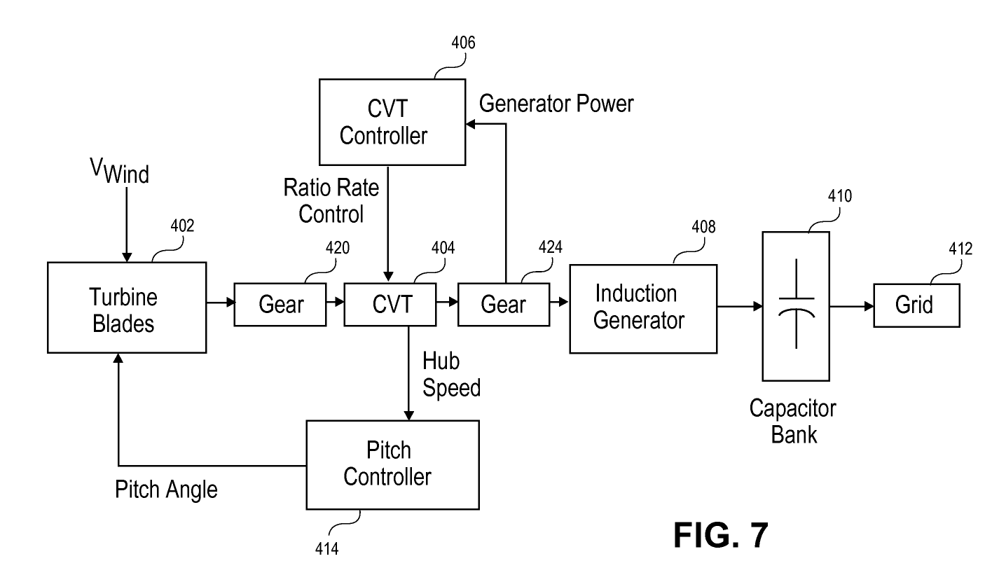

FIGS. 4 through 7 describe several different embodiments of wind turbine systems that employ the advanced CVT controls that enable the system to operate substantially continuously at peak power regardless of wind speed conditions. Turbine blades 402 provide the mechanical energy from the wind and provide it to CVT 404. CVT 404 operates under control of CVT controller 406 which may operate as described herein. The output shaft of CVT 404 provides the input into induction generator 408.—which may be a doubly fed induction generator, a singly fed induction generator or a permanent magnet generator.

CVT 404 may also give control indications to pitch controller 414 to control the pitch angle of the blades with regard to the wind direction. It should be appreciated that as the CVT 404 transmission is supplying the induction generator with proper operating conditions, there may be little or no need for pitch control to fine tune the pitch angle of the blades to insure that the generator is running within specifications. In one embodiment, there is no pitch controller. In another embodiment, the pitch controller may only be needed to reduce power in extremely high wind conditions in order to prevent damage to the system. Electricity from the induction generator may be fed to, or augmented by, a capacitor bank. Yet another embodiment might be to incorporate a pitch controller as only an inexpensive fine vernier pitch trim tabs to further enhance turbine efficiency. Then high wind conditions may be accounted for by other controls such as turning the turbine to be oblique to the wind or other techniques to limit turbine speed.

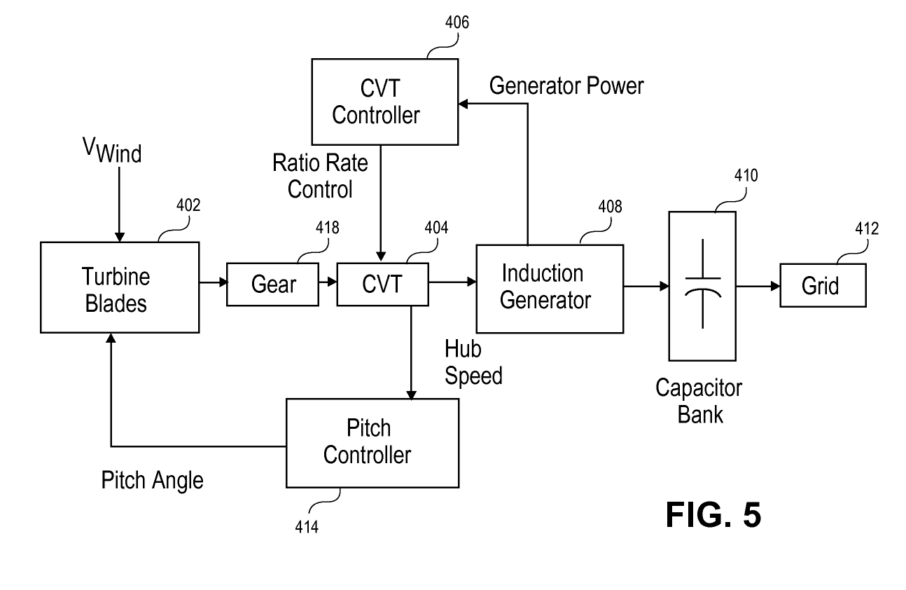

FIGS. 5 through 7 depict several different embodiments of a wind turbine system characterized in that each provides a gear set either before (418) the CVT, after (420) the CVT, or both before (422) and after (424) the CVT, respectively. These embodiments may provide for practical design limits—for example, to better match the torque-speed characteristics of the CVT system to the electrical system, intermediate gear ratios may be desirable either before, after or both before and after the CVT.

In another embodiment, a characteristic of the CVT might be to provide an equal underdrive and overdrive ratio. Thus to provide the possible match of the generator speed over a range of wind speed, it may be possible to replace one stage of the conventional multistage gear box. Typical fixed ratio gear boxes may consist of multistage gear ratios to accomplish the approximately 100 to 1 step up ratio desired to match wind blade or rotor speed to the required generator speed. This may be done with 3 stages or more.

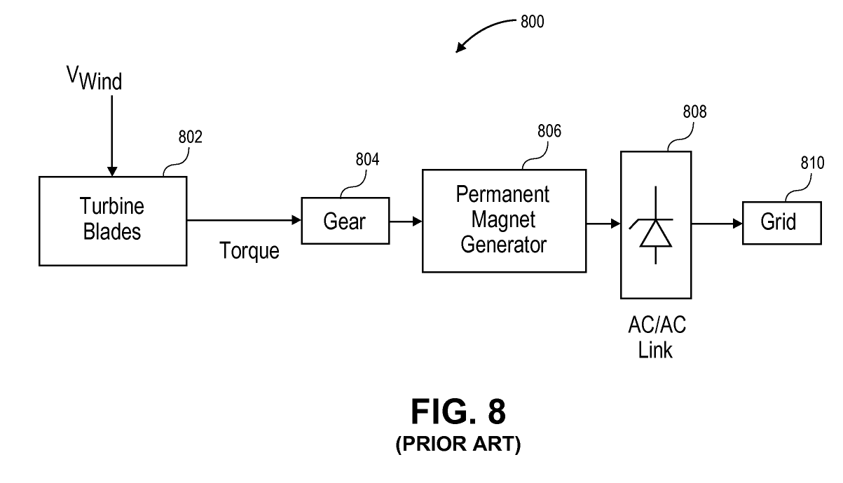

In the area of very low power wind turbine systems, it is known in the art to use permanent magnet generators. FIG. 8 depicts one such conventional system 800. Turbine blades 802 transmit the mechanical energy of the wind to gearset 804, which in turn, spins a permanent magnet within generator 806 to create the electrical energy. AC/AC link 808 provides the necessary conversion of the electrical conditions (e.g. frequency and phase) to match grid 810. One characteristic of this embodiment, while it is low cost, is the fact that the power capture range for this system may be limited. This is mainly due to the requirement that the generator operate at a sufficiently high speed that adequate voltage is available to facilitate power generation to the load. This may reduce the energy capture for the system.

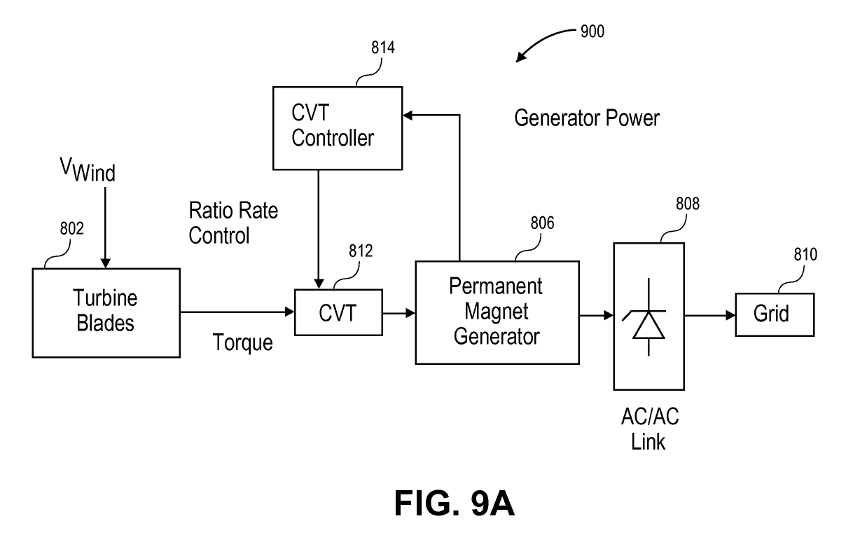

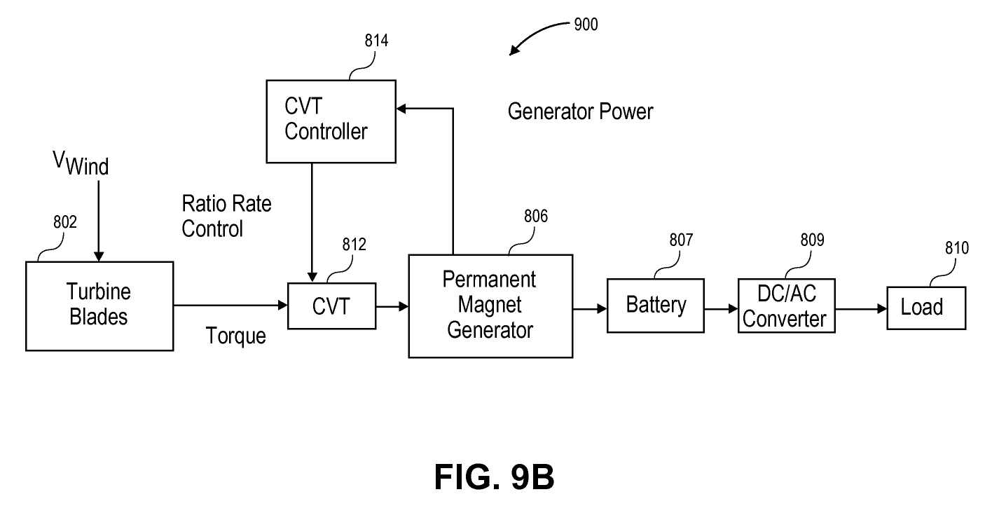

FIG. 9A shows a low power embodiment of the present system 900. System 900 and system 800 have many of the same component blocks, except that instead of using just a gear set 804, system 900 employs a gear set in combination with a CVT 812 and controller 814 which supplies CVT 812 with control signals, discussed above, to operate at substantially peak power. The addition of the CVT 812, while it may add some cost, may significantly increase the range of wind speeds that provide power generation and reduce significantly the system payback time.

A low power system might be characterized from a few hundred watts to 1000 to 5000 W. Thus the blade diameter may be small; on the order of one meter to ten meters. These small turbines tend to run at higher rpm—e.g. from a few hundred to about 1000 rpm. The generator may generate DC current either directly or through rectification of AC. In one alternative embodiment of FIG. 9B where DC is generated directly by the generator, a battery 807 and DC/AC inverter 809 might replace the AC/AC link in block 808 of FIG. 9A. In yet another alternative embodiment where the generator generates AC current, then a rectifier and battery could be placed in block 807 and DC/AC inverter may be placed in block 809 of FIG. 9B. Thus, these systems can store the power generated in a bank of batteries for use at a later time. These small turbines may be used for home electrical supply to displace AC grid electric use from normal sources. These small turbines may use a CVT to optimize DC power only since there is no need to match frequency as described above.

In another embodiment, it may be desirable to maximize the power into the batteries by adjusting the speed of the fixed pitch wind turbine by the CVT. This may be accomplished by maximizing the current into a battery bank or ultra-capacitor bank of a particular voltage. In such a case, it may be desired to maximize current by adjusting the ratio of the CVT—e.g. dI/dt=0

As mentioned, to convert DC into AC to match the conventional power line, a DC to AC converter may be used. These converters are generally single phase and generate in phase synchronized electric energy at a fixed voltage for household use or for local substation use in a neighborhood. The energy displaces the use of energy from the conventional power plants, thus displacing the use of fossil fuel for energy and using renewable wind. These small generators are designed to save electrical cost for the private home and business owners. The addition of the CVT in these wind generators tends to extend the range of operation relative to wind speed and allows the maximization of power generated at each wind speed thus reducing the pay back time of the wind turbine system.

While the techniques and implementations have been described with reference to exemplary embodiments, it will be understood by those skilled in the art that various changes may be made and equivalents may be substituted for elements thereof without departing from the scope of the appended claims. In addition, many modifications may be made to adapt a particular situation or material to the teachings without departing from the essential scope thereof. Therefore, the particular embodiments, implementations and techniques disclosed herein, some of which indicate the best mode contemplated for carrying out these embodiments, implementations and techniques, are not intended to limit the scope of the appended claims.

What is claimed is:

1. A wind turbine system comprising:
a plurality of turbine blades;
a continuously variable transmission (CVT) coupled to said plurality of turbine blades;
a generator coupled to said continuously variable transmission; wherein said generator generates electricity and outputs said electricity to a load;
a controller providing control signals as a function of power to said continuously variable transmission.

2. The wind turbine system as recited in claim 1 wherein said controller continuously maintains the parameter dP/dR substantially zero.

3. The wind turbine system as recited in claim 2 wherein said controller provides control signals to control the rate of change of ratio of said transmission.

4. The wind turbine system as recited in claim 3 wherein said control signal as a function of the rate of change of ratio of transmission comprises dP/dR as a parameter.

5. The wind turbine system as recited in claim 1 further comprising:
a pitch controller to control the angle of the turbine blades with respect to wind and turbine generator conditions.

6. The wind turbine system as recited in claim 5 wherein said pitch controller provides control signals solely for high wind conditions.

7. The wind turbine system as recited in claim 1 wherein said generator is one of a group, said group comprising a permanent magnet generator, DC generator, a singly fed induction generator or a doubly fed induction generator.

8. The wind turbine system as recited in claim 1 further comprising a gearset coupled to said CVT.

9. The wind turbine system as recited in claim 8 wherein said gearset is coupled to said turbine blades before said CVT.

10. The wind turbine system as recited in claim 8 wherein said gearset is coupled to said CVT before said generator.

11. The wind turbine system as recited in claim 8 wherein said gearset is coupled between said turbine blades and said CVT and between said CVT and said generator.

12. A wind turbine system comprising:
a plurality of turbine blades;
a continuously variable transmission (CVT) coupled to said plurality of turbine blades;
a permanent magnet generator coupled to said continuously variable transmission; wherein said generator generates electricity and outputs said electricity to a load;
a controller providing control signals as a function of power to said continuously variable transmission;
a battery to store electricity generated by said generator.

13. The wind turbine system of claim 12 wherein said system further comprises a DC to AC converter to match local load conditions.
